(19) United States
(12) Patent Application Publication
(10) Pub. No.: US 2007/0253000 A1
(43) Pub. Date: Nov. 1, 2007

(54) System and method for measuring distances, displacement and mechanical actions

(76) Inventors: Alberto Vallan, Pralungo (IT); Silvio Abrate, Savigliano (IT); Guido Perrone, Pavignano (IT)

Correspondence Address: PAUL A. FATTIBENE;FATTIBENE & FATTIBENE, 2480 POST ROAD, SOUTHPORT, CT, 06890, US

(21) Appl. No.: 11/786,254

(22) Filed: Apr. 11, 2007

(30) Foreign Application Priority Data
Apr. 21, 2006 (EP) 06008340.9

(51) Int. Cl. G01B 9/02

(52) U.S. Cl. 356/477

(57) ABSTRACT

An optical transducer adapted to detect external mechanical actions or forces acting comprising at least one sensing optical path (5) adapted to transmit at least one sensing optical signal (b′) and to emit at least one sensing output electrical signal (d) along with at least one reference path (4) adapted to emit at least one output electrical reference signal (e). Moreover, at least one portion (5′) of the at least one optical path (5) is adapted to be exposed to external mechanical actions or forces, so that the transmission of the sensing optical signal (b′) through the sensing optical path can be modified as a result of the mechanical actions or forces, so that a phase shift between the sensing electrical signal (d) and the reference electrical signal (e) is generated. Furthermore, the at least one reference path (4) comprises phase shifting means (11) adapted to maintain the phase shift between the at least one output sensing electrical signal (d) and the at least one output reference electrical signal (e) at a constant value in absence of any mechanical action or force exerted on the at least one sensing optical path (5), resulting in the working point or operating range of the transducer being kept within a range centered on a predefined phase shift, thus allowing improved sensitivity of the transducer.

### FIELD OF THE PRESENT INVENTION

The present invention relates to the measurement of distances, displacements and forces. In particular, the present invention relates to the measurement of displacements caused by mechanical forces, such as, for example, tractions or compressions and the relative forces producing said displacements. In more detail, the present invention relates to the measurement of displacements and forces by using optical transducers. Still in more detail, the present invention relates to the measurement of displacements and forces by using optical transducers and/or sensors comprising low cost optical fiber components. Finally, the present invention relates to a method, a device and a system for measuring distances, displacements and forces, with said device and system comprising low cost optical transducers and/or sensors.

### BACKGROUND OF THE INVENTION

Recently, much development work has been devoted to the development of devices adapted to measure and/or detect mechanical forces and displacements in a very reliable manner. Among the devices and systems developed and proposed, systems and devices based on very sophisticated electronic assemblies have became the most largely used devices and systems. This, in particular, was due to development in the field of integrated circuits and the corresponding reduction in size of circuits having very complicated functions, allowed the manufacture of very small electronic transducers, adapted to be used for different purposes and under very difficult conditions. For instance, electronic transducers are known, the size of which is kept less than a few cubic millimeters. Moreover, recent developments in the field of computing means, in particular, in the field of software used to process large quantities of data in a short time, allowed the data detected by the electronic transducers to be processed in an automatic and reliable manner. Finally, the decreasing costs of electronic systems, allowed for containing the costs for producing electronic transducers, thus allowing electronic transducers to be used for several purposes and applications.

However, in spite of all the advantages cited above offered by electronic transducers, electronic transducers are not free from drawbacks. The most relevant drawback affecting electronic transducers arises from the fact that electrical current is needed for operating the electronic transducers. It is appreciated that in the case of a force acting on an electronic transducer, the electrical current flowing through the transducer is influenced by the force acting on it, so that the variations in the current flow may be detected and used for obtaining an indication of the intensity of the force acting on the transducer. However, the electrical current flowing through the electronic transducers may also be influenced by the external environment, thus rendering electronic transducers less reliable for applications in critical environments, such as in structures exposed to electrostatic discharges during thunderstorms or in electromagnetically noisy industrial premises. Moreover, it may become difficult or risky to use electronic transducers in storage areas of highly flammable materials. Finally, some electronic transducers are also not suitable for biomedical applications because the risk of electrocution may arise.

Accordingly, in view of the problems explained above, it would be desirable to provide a technology or device that may solve or reduce these problems. In particular, it would be desirable to provide transducers suitable to be used in structures exposed to electrostatic discharges and/or in noisy industrial premises, or even in storage areas of highly flammable materials. In the same way, it would be desirable to provide transducers for measuring and/or detecting forces, suitable for use in biomedical applications. Furthermore, it would be desirable to provide transducers having low cost, light weight, reduced size and minimal invasiveness. It would also be desirable to provide transducers for the purpose of reliably measuring forces and displacements, in combination with being of low cost, simple and able to be used in well-known equipment.

Some attempts have been made recently for overcoming the drawbacks affecting electronic force measurement systems. In particular, some efforts have been devoted to the development of optical transducers to measure forces and the displacements they cause. Many of these optical transducers are based on the premise that forces may be measured and/or detected using evaluations of the effects on light transmitted through an optical path caused by forces acting, either directly or indirectly on said optical path. In particular, the working principle of many optical transducers is based on the variation in the photocurrent detected at the output of an optical path as a consequence of a variation in the link attenuation due to the force under test. In fact, it has been observed that a relationship may be established between the photocurrent detected at the output of an optical path with the mechanical stress acting on the mechanical path. Unfortunately, however, the known optical transducers are not free from drawbacks and some of them are also not as reliable as desired. Finally, assembling and manufacturing many of the known optical transducers is quite cumbersome and, therefore, quite expensive.

It would therefore be desirable to provide optical transducers overcoming the drawbacks effecting prior art optical transducers such as, for instance, reduced reliability, reduced application range, and high costs, while maintaining a satisfactory sensitivity.

### SUMMARY OF THE PRESENT INVENTION

In general, the present invention is based on the consideration that forces, in particular, mechanical forces and/or actions such as tractions and/or compressions may be detected and/or measured using the variations of light through an optical path caused by said mechanical actions acting, either directly or indirectly, on the optical path. In particular, the working principle of the present invention is based on the consideration that the variation in length of an optical path due to a mechanical force acting on the optical path causes the phase of an optical signal transmitted through the optical path to be shifted and/or modified so that, if the optical signal, when exiting said optical path, is converted into an electrical signal, the variation in length of the optical path results in the phase of the electrical signal being also shifted and/or modified, thus differing from the phase the electrical signal would have had in the absence of any mechanical action acting on it. Accordingly, if a second path is used, say a reference path, with said second path being adapted to emit a reference electrical signal and not being subjected to the mechanical actions acting on the optical path (the sensing path), the electrical signal exiting the sensing optical path will have a phase differing from that of the electrical signal exiting the reference path, with said difference being related to the variation in length caused by a mechanical action or stress acting on the sensing optical path. Accordingly, by comparing the phases of the signals at the output of the sensing and reference paths, it is possible to determine the variation in the sensing path length and to relate this variation to the mechanical action acting on the sensing optical path. Although this detection approach may appear to be quite general in principle, it has been revealed to be very reliable for the purpose of detecting and/or measuring forces, in particular, mechanical forces, such as, for example, tractions or compressions or tension and compressive forces. Moreover, this detection approach allows the implementation of components suitable to improve the resolution, the sensitivity, the accuracy and reliability of the measurements. Moreover, when fibers, such as, for instance, polymer optical fibers (POF) are used for the purpose of realizing the sensing optical path, further advantages arise in terms of costs, besides the advantages common to the other types of optical fibers such as, for instance, lightweight, minimal invasiveness, immunity to electromagnetic interferences and impossibility to start a fire or an explosion. However, copper wire or coaxial cable may be used for the reference path. Finally, further advantages also arise due to the less demanding mechanical tolerances and the availability of low cost sources and photo detectors. A detecting and/or measuring approach according to the present invention can be used in the case of critical environments such as in electromagnetically noisy industrial premises, in storage areas of highly flammable materials, in structures exposed to electrostatic discharges during thunderstorms and in the monitoring of monuments or art pieces in general. The absence of electrical currents flowing through the sensing area of the sensor according to the present invention makes this transducer also ideal for biomedical applications avoiding the risk of electrocution. It is also possible to control several sensing points or areas, and the corresponding transducers, simultaneously, by means of complex yet quite inexpensive networks of sensors according to the present invention. Moreover, if suitable software is used, it is also possible to control the sensors via remotely using a network connection or the internet or web using standard protocols such as, for instance, the TCP/IP protocol.

It should also be appreciated that the detecting approach according to the present invention and, accordingly, the detecting transducers according to the present invention, contrary to some prior art optical transducers, does not require optical fibers to be interrupted, such as, for instance, in the case of optical transducers based on the reflection and/or absorbance of light, so that the whole transducers and detecting means and/or devices according to the present invention can be better isolated from dust, rain or the like, thus rendering the detecting transducers and/or devices according to the present invention particularly suitable for outdoor applications.

On the basis of the considerations as stated above, there is provided an optical transducer adapted to detect external mechanical actions acting on the transducer, the transducer comprising at least one sensing optical path adapted to transmit at least one sensing optical signal and to emit at least one sensing output electrical signal and at least one reference path adapted to emit at least one output electrical reference signal. Moreover, at least one portion of the at least one optical path is adapted to be exposed to external mechanical actions or forces, so that the transmission of the sensing optical signal through the sensing optical path is modified, resulting in a phase shift between the sensing electrical signal and the reference electrical signal.

In particular, a first embodiment of the present invention relates to an optical transducer wherein said at least one reference path comprises phase shifting means adapted to maintain the phase shift between the at least one output sensing electrical signal and the at least one output reference electrical signal at a constant value in the absence of any mechanical action or force exerted on the at least one sensing optical path.

According to a further embodiment, the present invention relates to an optical transducer comprising means for collecting the at least one output electrical reference signal and to emit a further electrical reference signal, with the further electrical reference signal being shifted in phase with respect to the output reference electrical signal of about 90°.

According to still a further embodiment of the present invention, an optical transducer is provided wherein the optical path is adapted to transmit at least two optical sensing signals with corresponding different wavelengths, with only one signal of the two sensing optical signals entering the at least one sensing portion. Moreover, the optical path further comprises means adapted to receive the at least two sensing optical signals and to convert the at least two sensing optical signals into two corresponding output sensing electrical signals.

According to another embodiment of the present invention, an optical transducer is provided wherein the at least one portion of the at least one optical path has a predefined length adapted to be modified as a result of mechanical actions or forces acting on the at least one portion.

According to still another embodiment of the present invention, an optical transducer is provided wherein the at least one optical path comprises optical emitting means adapted to receive at least one input sensing electrical signal and to convert the at least one input sensing electrical signal into the at least one sensing optical signal.

According to a further embodiment of the present invention, an optical transducer is provided wherein the at least one reference path comprises a reference optical path adapted to transmit at least one reference optical signal and optical receiving means adapted to receive said at least one optical reference signal and to convert the at least one optical reference signal into the at least one reference electrical signal.

According to another embodiment of the present invention, an optical transducer is provided wherein the at least one portion of the at least one sensing optical path comprises at least two rectilinear portions disposed parallel to each other and joined by a curved portion.

According to a further embodiment, the present invention relates to an optical transducer is provided wherein the optical transducer comprises a plurality of sensing optical paths each adapted to transmit at least one corresponding sensing optical signal and to emit at least one corresponding sensing output electrical signal and each comprising at least one portion adapted to be exposed to external mechanical actions or forces. Moreover, the optical transducer comprises one reference path adapted to emit at least one electrical signal.

According to a further embodiment of the present invention, a measuring device is provided for measuring and/or detecting mechanical actions or forces comprising at least one optical transducer and measuring means adapted to measure the phase shift between the at least one sensing electrical signal and the at least one reference electrical signal.

According to still a further embodiment of the present invention, a measuring device is provided comprising first measuring means and second measuring means, the first measuring means being adapted to collect the at least one sensing electrical signal and the at least one reference electrical signal and to emit a first output electrical signal, the second measuring means being adapted to collect the at least one output sensing electrical signal and a reference electrical signal shifted in phase by 90° with respect to the reference electrical signal and to emit a second output electrical signal so that the phase shift between the at least one reference electrical signal and the at least one sensing electrical signal can be measured as a function of the amplitude of one or both of the output electrical signals.

According to a further embodiment, the present invention relates to a measuring device wherein the measuring means comprise mixing means adapted to mix the electrical signals and to emit electrical signals and wherein the measuring means comprise a low-pass filter adapted to receive the electrical signals, and to emit electrical signals.

Still according to the present invention, a measuring method is also provided. The measuring method for measuring mechanical actions or forces comprises providing an optical transducer so that at least one portion of the at least one optical path is exposed to said mechanical actions or forces, entering at least one sensing optical signal into the at least one portion of the at least one sensing optical path and converting the optical signal into an output sensing electrical signal. Moreover, the method comprises inducing the at least one reference path to emit the at least one output electrical reference signal, shifting the phase of the at least one output electrical signal so as to maintain the phase difference between the at least one output sensing electrical signal and the at least one output reference electrical signal at a constant value in absence of any mechanical action or force exerted on the at least one sensing optical path and measuring the phase shift between the at least one output sensing electrical signal and the at least one output electrical reference signal.

According to a further embodiment of the present invention, a measuring method is also provided comprising fixing the opposed ends of the at least one portion of the at least one optical path to fixing means so that the mechanical actions or forces acting on the portion results in the length Ls of the portion being modified, thus generating a phase shift between the at least one output sensing electrical signal and the at least one output reference electrical signal.

Still a further embodiment of the present invention relates to a measuring method comprising measuring the phase shift between the output electrical sensing signal and the at least one output electrical reference signal in the absence of any mechanical action or force acting on the at least one portion of the at least one optical sensing path.

Further, additional embodiments of the present invention are defined in the appended claims.

### BRIEF DESCRIPTION OF THE DRAWINGS

Further advantages, objects and features as well as embodiments of the present invention are defined in the appended claims and will become more apparent with the following detailed description when taken with reference to the accompanying drawings, in which like features and/or component parts are identified by like reference numerals. In particular, in the drawings:

FIG. 1 is a schematic view of an optical transducer and a measuring device according to a first embodiment of the present invention;

FIG. 2 is a schematic view of a second embodiment of an optical transducer and a measuring device according to the present invention;

FIG. 3 is a schematic view of measuring means adapted to be used in combination with an optical transducer according to the present invention and adapted to be implemented in a measuring device according to the present invention;

FIG. 4 is a graph schematically depicting the dependence of the output signal of the optical transducer and the measuring device according to the present invention from the phase difference 6 between the sensing signal and the reference signal;

FIG. 5 schematically depicts a further embodiment of an optical transducer and a measuring device according to the present invention;

FIG. 6 relates to a schematic view of a further embodiment of an optical transducer and a measuring device according to the present invention;

FIG. 7 schematically depicts a further embodiment of an optical transducer and a measuring device according to the present invention;

FIG. 8 relates to a schematic view of a further embodiment of an optical transducer and a measuring device according to the present invention;

FIG. 9 schematically depicts an embodiment of a measuring device according to the present invention implementing a plurality of optical transducers and allowing, therefore, detection of a plurality of mechanical actions or forces acting on a corresponding plurality of sensing areas.

### DETAILED DESCRIPTION OF THE PREFERRED EMBODIMENTS

While the present invention is described with reference to the embodiments as illustrated in both the following detailed description and the drawings, it should be understood that the following detailed description, as well as the drawings, are not intended to limit the present invention to the particular illustrative embodiments disclosed, but rather the described illustrative embodiments merely exemplify the various aspects of the present invention, the scope of which is defined by the appended claims.

The present invention is understood to be of particular advantage when used for detecting and/or measuring mechanical actions, stresses or strains, such as, for example, tensions and/or compressions. For this reason, examples will be given in the following in which corresponding embodiments of the optical transducer and the measuring device according to the present invention are used for detecting both tractions or tensions and compressions as well as displacements caused by the tensile and/or compressive forces. However, it has to be noted that the use of the optical transducers according to the present invention is not limited to the detection and/or measurement of tractions or tensions and compressions and the resulting displacements; on the contrary, the optical transducer and the measuring device according to the present invention may also be used for the purpose of measuring and/or detecting different forces as well as distances. The present invention is, therefore, also useful for the measurement of all these forces, mechanical actions, distances and displacements, and the forces, displacement and distances described in the following are to represent any force, distance and displacement.

The first embodiment of an optical transducer and a measuring device according to the present invention will be described in the following with reference to FIG. 1.

In FIG. 1 reference 100 identifies a measuring device equipped with an optical transducer according to the present invention. Still in FIG. 1, reference numerals 5 and 4 identify a first and second path, respectively, in the following also referred to as sensing path and reference path, respectively. The sensing path 5 comprises an optical path adapted to transmit an optical sensing signal b′ and to emit an output reference signal d; to this end, means 6 are provided for receiving the optical signal b′ entering the optical path 5 and to convert the optical signal b′ into an electrical signal d. Reference numeral 8 identifies two fixed means for fixing the optical path 5 so as to define a sensing portion 5′ of the optical path 5 of a predefined length Ls. The fixed means or locks 8 are used to fix the sensing portion 5′ of the optical path 5 to a region whose displacement has to be monitored; in particular, the sensing portion 5′ is adapted to be exposed to a mechanical action or force resulting in the length Ls of said sensing portion 5′ being modified. By way of example, these mechanical actions or forces may comprise tensile or compression forces. Still in FIG. 1, reference numeral 1 identifies generator means for generating an electrical signal, for instance a RF signal a. Moreover, reference numeral 2 identifies divider means for dividing, not necessarily in an even way, the electrical signal a into two corresponding electrical signals b and c entering the sensing paths 5 and the reference path 4, respectively. Finally, reference e identifies an electrical signal exiting the reference path 4, whilst reference numeral 7 identifies measuring means for measuring the phase difference or shift between the electrical signals d and e, with said measuring means 7 being adapted to receive the electrical signals d and e and to emit a signal f. Moreover, reference numeral 3 identifies light emitting means for receiving the electrical signal b and converting said electrical signal b into a corresponding optical signal b′.

The working principle of the embodiment of the present invention depicted in FIG. 1 is based on the measure of the variation in the phase difference between the two signals d and e, due to a variation in the path length, in particular, in the length Ls of the sensing portion 5′, traveled by the optical signal b′ and can be summarized as follows.

The signal generator means 1 produces a RF signal a at a frequency f, to be determined on the basis of general considerations such as, for instance, the trade-off between costs and performances. In general, the higher the frequency used, the better is the resolution of the deformation measured although ambiguity problems may arise with large displacements; accordingly, in the case of coarse or relevant displacements, lower frequencies may be preferred. Alternatively, it is also possible to use a frequency-variable generator, allowing measurements both at a frequency low enough to avoid ambiguities and at a frequency high enough to obtain the achieved resolution. The RF signal generated by the generator means 1 is divided into two sub signals b and c, not necessarily in an even way, by the divider means 2. One output of the divider means 2 feeds the light emitting means 3 while the other output is connected to the reference path 4 so that the signals b and c enter the optical emitting means 3 and the reference path 4, respectively. For instance, the light emitting means 3 may comprise an LED, a laser diode or the like. The signal b is converted by the light emitting means 3 into a corresponding optical signal b′ which enters the sensing optical path 5, in particular, the sensing portion 5′ of the sensing optical path 5. The optical signal b′ is transmitted through the sensing portion 5′ of the sensing optical path 5 and subsequently enters the optical receiving means 6 where the optical signal b′ is converted into a corresponding electrical signal d. At the outputs of both the optical sensing path 5 and the reference path 4, the corresponding signals d and e are collected by the measuring means 7 for measuring or determining the difference in phase between the signals d and e. To this end, the measuring means 7 are adapted to emit a signal f which is subsequently collected by computing means (not depicted in FIG. 1); for instance, said computing means may comprise a digital acquisition (DAQ) card adapted to convert the electrical signal f into a digital signal and a computing unit such as, for instance, a PC equipped with software adapted to analyze the data exiting the measuring means 7. Different optical fibers may be used for the purpose of realizing the sensing optical path 5; for instance, depending on the circumstances, polymer optical fibers (POF) can be used or, alternatively silicate fibers. The optical receiving means 6 may comprise photodiodes followed by a low noise amplifier. The reference arm or reference path 4 can be realized by any means suitable to connect the divider means 2 with the phase measuring means 7. Typically, the reference path 4 comprises a coaxial cable or a microstrip circuit but it can also comprise, for example, another optical fiber. In this case, the reference path 4 will comprise optical emitting means adapted to receive the electrical reference signal c and to convert said electrical reference signal c into a corresponding optical reference signal, as well as optical receiving means for receiving the optical reference signal and converting the optical reference signal into the electrical reference signal e.

Considering now a sinusoidal generator 1, the RF signal emitted by the sinusoidal generator 1 can be described by
a(t)=A cos(ωt) (1)

A being a constant.

Assuming an ideal behavior for the power divider means 2, the signals b and c emitted by said power divider means 2 can be described, respectively, by
b(t)=B cos(ωt) c(t)=C cos(ωt) (2)

where the constants B and C are related to A by the splitting ratio of the power divider means 2. Accordingly, the signals d and e entering the phase measuring means 7 can be described by
d(t)=D cos(ωt+φ) e(t)=E cos(ωt+θ) (3)

the constants D and E being related to B and C by the attenuations of the sensing path 5 and the reference path 4, respectively. The phase shifts φ and θ in equation (3) depend on the propagation velocity v of the signals in the sensing and in the reference paths 5 and 4 and on their lengths as well as on the phase delay introduced by any device along the path.

It appears, therefore, clearly from equation (3) that a variation in the length of the sensing path 5, in particular, in the length of the sensing portion 5′, due to an external mechanical action or force such as, for instance, a tensile or a compression force, will produce a variation of φ and, therefore, a variation of δ(φ−θ), and, in turn, a variation of the output signal f exiting the phase measuring means 7.

Accordingly, if the natural phase shift of the optical transducer and the measuring device depicted in FIG. 1 is detected, namely the phase difference or shift between the two signals d and e in the absence of any mechanical action acting on the optical path, on the sensing portion 5′ of the optical path 5, any mechanical action or force acting on the optical path 5, on the sensing portion 5′ of the optical path 5, and resulting in a variation of the length of the optical path 5, in the length Ls of the sensing portion 5′ of the optical path, will also produce a variation of the value of the phase shift δ between the sensing electrical signal d and the reference electrical signal e; accordingly, detecting the variation of the phase difference δ permits the detection of the mechanical actions or forces acting on the optical path as well as any displacements such as, for instance, displacements of the fixed means or blocks 8. For example, for the purpose of measuring the elongation of a steel or concrete beam, the sensing portion 5′ will be fixed directly throughout its whole length of the beam using a suitable type of glue. On the contrary, in those applications in which the distance between two reference points has to be measured, the opposed end portions of the portion 5′ will be fixed to these reference points. In the same way, in other applications in which it is necessary to measure the strain in short predefined regions only, the optical path will be made of fibers kept loose within a protective sleeve and only the portion corresponding to the predefined regions will be attached or glued.

It appears clearly from the description given above that the resolution of the optical transducer and the corresponding measuring device depicted in FIG. 1 is related to the dependence of the variation of the difference in phase δ on the variation in length of the sensing portion 5′ generated by a mechanical action or force acting on the sensing portion 5′. That is to say, that if small variations in length correspond to relevant variation in the phase shift δ, also light mechanical actions or forces producing small variations in the length of the sensing portion 5′ can be detected; on the contrary, if only big or relevant variation in length of the sensing portion 5′ produce relevant variations in the phase shift δ between the two signals d and e, only relevant mechanical actions or forces producing relevant variations in length may be detected, accordingly. In other words, the sensitivity of the optical transducer and the measuring device depicted in FIG. 1 depends on the relationship between the variation in length of optical path 5, of the sensing portion 5′, and the corresponding variation in the phase shift δ.

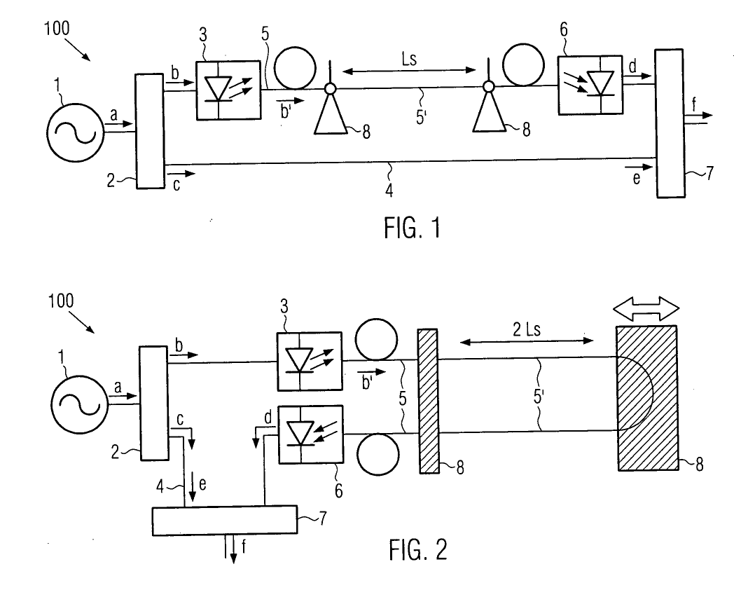

In the following, a further embodiment of an optical transducer and a measuring device according to the present invention and offering improved sensitivity will be described with reference to FIG. 2, where like features and/or component parts already described with reference to FIG. 1 are identified by like reference numerals.

The embodiment of the present invention depicted in FIG. 2 is substantially similar to that depicted in FIG. 1 and described above but differs from the embodiment of FIG. 1 in that the sensing portion 5′ has a length corresponding to twice the length Ls of the sensing portion 5′ of the embodiment depicted in FIG. 1. In particular, as apparent from FIG. 2, this is obtained by providing an optical path 5 comprising two straight or rectilinear portions joined by a curved portion. Accordingly, if the fixed means 8 are disposed as depicted in FIG. 2, namely so as to be fixed to the opposed end portions of said two sensing portions 5′, it appears clearly that a mechanical action or force acting on the transducer, on both these two sensing portions 5′, will produce a variation in length of each sensing portion 5′, resulting in a total variation in length of the optical path 5 more relevant or greater than the variation in length than the same mechanical action or force would have produced on the sensing portion 5′ of the optical transducer depicted in FIG. 1. In particular, the variation in length produced by a mechanical action or force acting on both the two rectilinear sensing portions 5′ of the transducer of FIG. 2 may produce a total variation in length of these two sensing portions 5′ corresponding to twice or more the variation in length the same mechanical action or force would have produced on the sensing portion 5′ of the transducer of FIG. 1. It results, therefore, that in the case of the optical transducer of FIG. 2, even light mechanical actions or forces will result in a variation of the phase difference between the two signals d and e being relevant enough to be detected and measured by the phase measuring means 7.

Moreover, the setup described in FIG. 2 simplifies the power supply distribution since it has the practical advantage of having all the optoelectronic and electrical devices on the same side.

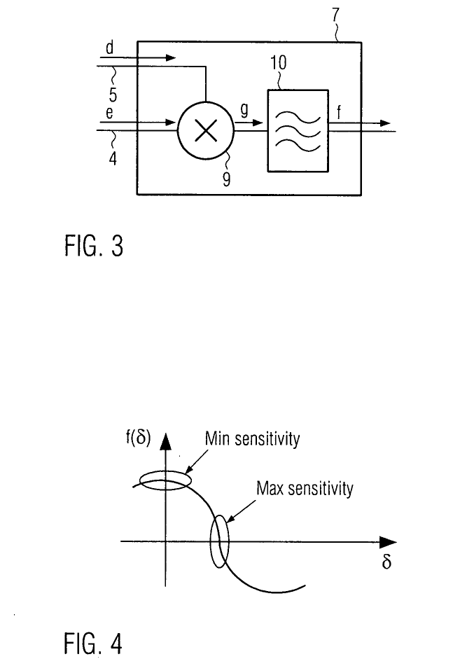

In the following, an example of measuring means adapted to be used in combination with the optical transducer according of the present invention and adapted to be implemented in a measuring device according to the present invention will be described with reference to FIG. 3, wherein, as usual, like features and/or component parts are identified by like reference numerals.

In FIG. 3, reference numeral 9 identifies mixer means for mixing signals whilst reference numeral 10 identifies a low-pass filter. The mixer means 9 are adapted to receive the output sensing electrical signal d exiting the sensing path 5 and the output reference electrical signal e exiting the reference path 4. The mixer means 9 can be of any type, namely either passive or active. Alternatively, according to the circumstances, analogical multipliers can be used for the purpose of mixing the two signals d and e. It has however to be understood that, in the light of the present invention, mixing the signals d and e means receiving said signals d and e and emitting a signal g which subsequently enters the low-pass filter 10, from which a further output signal f is emitted. The way in which the variation in the phase shift between the signals d and e maybe detected by the measuring means 7, of FIG. 3, can be summarized as follows.

The signals d and e depicted in FIG. 3 have the same expressions already written above. Assuming an ideal behavior for the mixer means 9, the signal g exiting said mixer means 9 may be described by
g(t)=D cos(ωt+φ)·E cos(ωt+θ)=½·D·E·[cos(2ωt+φ+θ)+cos(φ−θ)] (4)

so that, if the low-pass filter 10 has an ideal behavior, the signal f exiting the low-pass filter 10 may be described by
f(t)=½·D·E·cos(φ−θ)=k cos(δ) (5)
where δ is equal to φ−θ and k is proportional to the signal amplitudes.

This clearly shows that the signal exiting the measuring means 7 is proportional to the phase difference or shift δ which, in turn, depends on the lengths of the sensing and reference paths, although with a non-linear dependence.

At the beginning of the measurement session, and in absence of any mechanical action or force on the transducer, the value of f is recorded, say f_{z}. Accordingly, if a mechanical action or force is applied to the transducer, for instance a tensil or compression action or force on the sensing portion 5′ of the optical path 5, the value of f changes, thus allowing the measurement of the displacement which can be then described by
f−f_{z}∝ΔLₛ.

It results, therefore, that if the signal f is collected, the variations of the signal f may be put into relationship with the variation in length of the sensing portion 5′ of the optical path 5 and, in turn, with the mechanical action acting on the transducer. To this end, the signal f is sent to computing means, for instance to a personal computer, typically through a DAQ card, for the elaboration or processing of the signals and the recovery of the amplitude of the mechanical action or force from the phase variation information.

Since the phase variation is proportional also to ω, a resolution in the displacement in the order of a tenth of a micrometer requires the use of frequencies in the GHz range, while a resolution of a tenth of a millimeter is possible using a frequency of a few MHz.

Despite all the previously described advantages, the optical transducers and the measuring devices depicted in FIGS. 1 and 2 are not completely free from drawbacks. In particular, the first drawbacks affecting the optical transducers and the measuring devices of FIGS. 1 and 2 relates to the fact that the sensitivity of both the optical transducer and the measuring device depends on the value of δ in absence of any mechanical action or force acting on the transducer, i.e. on the phase difference between the signals d and e entering the measuring means 7. This in particular appears clearly from FIG. 4 where there is depicted the relationship between the signal f exiting the measuring means 7, in particular, the low-pass filter 10, and the variation in the phase difference 6 between the signals d and e entering the measuring means 7, in particular, the mixer means 9, of FIG. 3. In fact, as apparent from FIG. 4, since the relationship between the signal f and δ may be represented as a cosine, if the value of δ in absence of any mechanical action or force approximately corresponds to 0, the working point or operating range of the transducer will be located in the region of minor sensitivity depicted in FIG. 4, so that variations of δ in the range of ±30° will result in small variations of the output signal f, so that it will be difficult to appreciate and/or to recover the mechanical action or force to which these variations of δ are due. On the contrary, if the phase shift between the two signals d and e in absence of any mechanical action or force acting on the transducer substantially corresponds to 90°, the working point or operating range of the transducer will be located in the region of more sensitivity depicted in FIG. 4, so that even small variations of δ due to less relevant actions acting on the transducer will result in a relevant variation of the output f, thus allowing the variation of δ to be detected and the corresponding variation in length of the sensing portion 5′ or the mechanical action or force to be obtained.

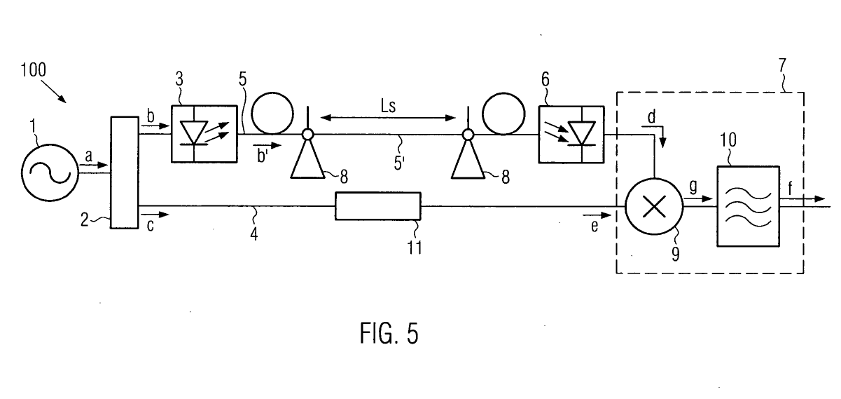

An example of a further embodiment of an optical transducer and a measuring device adapted to keep the working point or range at which the transducer operates centered at approximately 90° will be described in the following with reference to FIG. 5, wherein, as usual, like features or component parts already described with reference to previous figures are identified by like reference numerals.

The optical transducer and the measuring device of FIG. 5 additionally comprise a phase shifter 11. In particular, the phase shifter 11, in the example depicted in FIG. 5, is added to the reference path 4; however, according to the circumstances, the phase shifter 11 could also be added to the sensing optical path 5. The purpose of the phase shifter 11 is that of adjusting, in the absence of any mechanical action or force acting on the transducer, on the sensing portion 5′, the phase difference 6 between the sensing electrical signal d and the reference electrical signal e so as to maintain the phase difference δ to be approximately 90°. In this way, as apparent from FIG. 4, the working point of the transducer is kept in the region of maximum sensitivity, namely in the region centered to approximately 90°. The simple solution depicted in FIG. 5 results in dramatic improvement in the sensitivity of the transducer and the measuring device according to the present invention so that even less relevant or small mechanical actions or forces such as, for instance, tension or compressions or small displacements may be detected and measured.

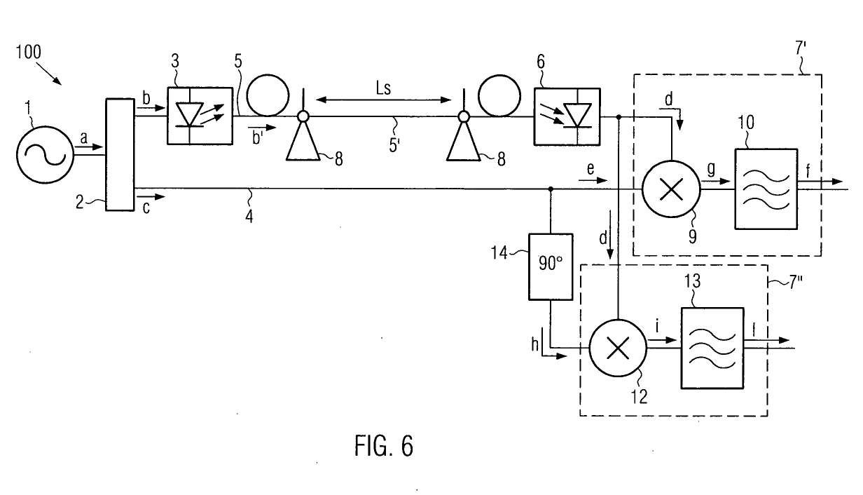

A further drawback affecting the embodiments of the present invention described above with reference to FIGS. 1 to 5 relates to the fact that, as apparent from equation (5), the output of the low-pass band filter 10 not only depends on the phase difference between the two signals d and e but also on the amplitude of these two signals. This implies that any variation in the received power, in the power of one or both of the two signals d and e, entering the phase meter or phase measuring means 7 and not due to a mechanical action or force acting on the transducer but for instance, to a variation of the optical attenuation in the optical path or of the electrical attenuation in the reference path 4 will be indistinguishable from a variation in the relative path lengths. In other words, it will not be possible to appreciate whether a variation in the output f exiting the phase measuring means 7 is really due to a variation in the phase difference between the signals d and e, resulting from a mechanical action acting on the transducer, or on a different reason generating a variation in the input power of one or both of the two signals d and e. Accordingly, a further embodiment of an optical transducer and a measuring device according to the present invention and adapted to overcome or at least to minimize this further drawback will be described in the following with reference to FIG. 6 wherein, as usual, like features and/or component parts already described above with reference to previous figures are identified by the same reference numerals.

In FIG. 6, reference numeral 14 identifies a phase shifter adapted to introduce a phase shift of about 90° to the reference signal c exiting the power divider means 2. However, the most important difference between the embodiment of FIG. 6 and the embodiments of FIGS. 1, 2 and 5 relates to the fact that, in the embodiment of FIG. 6, two measuring means 7′ and 7″ of the kind depicted in FIG. 3 are used. In particular, the measuring means 7′ comprise a first mixer 9 and a first low-pass band filter 10; the mixer 9 is adapted to collect the two signals d and e and to emit a corresponding signal g which is in turn collected by the low-pass band filter 10, from which a corresponding signal f is then emitted. The second measuring means 7″ comprise a second mixer 12 adapted to collect the sensing signal d and a reference signal h exiting the phase shifter 14, namely the reference signal c shifted by 90°. The signal i exiting the second mixer 12 enters the second low-pass band filter 13, from which the signal l is emitted.

The working principle of the embodiment depicted in FIG. 6 may be summarized as follows.

Supposing an ideal behavior for the phase shifter 14, the reference signal h exiting said phase shifter 14 may be described by
h(t)=E sin(ωt+θ) (6)

so that the output signal i of the mixer 12 may be described by
i(t)=D cos(ωt+θ)·E sin(ωt+θ)=½·D·E·[sin(2ωt+φ+θ)−sin(φ−θ)] (7)

After the ideal low-pass band filter 13 the output signal l may be described by
l= 1/2·D·E·|sin(φ−θ)|=k sin(δ) (8).

Accordingly, when the sensitivity of one of the two measuring means 7′ and 7″ is at its minimum, the other is at the maximum and vice versa. In other words, the working point or operating range of at least one of the two measuring means 7′ and 7″ is always maintained in the region of maximum sensitivity depicted in FIG. 4, namely in a region centered on about 90°.

Moreover, the outputs f and l can be used also to avoid the dependence of the measurement from the received power since the power can be estimated considering that
\sqrt{f+l²}=D·E·\sqrt{cos² δ+sin² δ}=D·E (8′)

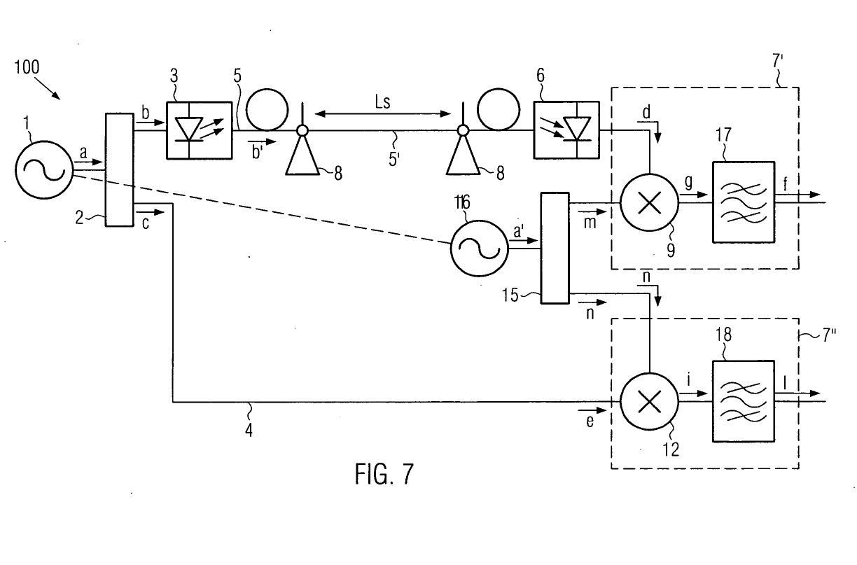

There is, however, a further drawback affecting the embodiments described above with reference to FIGS. 1, 2, 5 and 6, namely the drawback related to the fact that the output of the measuring means 7, 7′ and 7″, in particular, the output of the low-pass band filter 10 and 13 is a DC value, meaning that this output is sensitive to the offsets introduced into the various stages composing the optical transducer and the measuring device. Accordingly, with the embodiments depicted in FIGS. 1, 2, 5 and 6, it may become difficult to appreciate whether a variation in one of the output signals f and l is due to a variation in the phase difference between either the entering signals d and e or the entering signals d and h due to a mechanical action or force acting on the transducer or sensing portion 5′, or whether the variation as detected in one of the output signals f and l is rather due to a variation in the phase difference between either the signals d and e or the signals d and h which is however not due to any mechanical action or force acting on the transducer or sensing portion 5′, but for instance to an offset introduced by one of the stages composing the set up. Accordingly, a further embodiment of a transducer and a measuring device according to the present invention and allowing to overcome both this further drawback and the other drawbacks mentioned above will be described in the following with reference to FIG. 7, wherein, again, like features and/or component parts already described above with reference to previous figures are identified by like reference numerals.

The most important difference between the embodiment depicted in FIG. 7 and those described above with reference to previous figures relates to the fact that the embodiment of FIG. 7 additionally comprises second generator means for generating a signal 116 and a second power divider 15; the signal a′ generated by the second generator means 116 enters the power divider 15 from which two signals m and n are output. The signal m, together with the sensing electrical signal d enters the first measuring means 7′ comprising a first mixer 9 and a first band-pass filter 17 centered at a frequency f₀. In the same way, the second signal n and the reference electrical signal e enters the second measuring means 7″ comprising a second mixer 12 and a second band-pass filter 18 centered at the same frequency f₀.

The purpose of the embodiment depicted in FIG. 7 is always that of sensing and/or detecting a mechanical action, force or a displacement or a force acting on the transducer through a variation in the paths followed by the sensing signal d(t) and the reference signal e(t); however, in the present case, the variation in the paths followed by the two signals d and e are not seen as a variation of the phase shift between the two signals d and e, but as the time delay between them. Moreover, to improve the resolution, this time delay is not measured directly between the two signals d and e but between two signals f(t) and l(t) exiting the first measuring means 7′ and the second measuring means 7″, respectively.

The first generator means 1 generates a signal a at a frequency f₁, whilst the second generator means 116 generates a signal a′ at a frequency f₂ that differs from the frequency f₁ by a small quantity f₀. The second generator means 116 is locked to the first generator 1 to ensure that the frequency difference f₀ is kept substantially constant. Accordingly, either
f₂=f₁+f₀ or f₂=f₁−f₀ with f₀<<f₁ (10).

The signal a exiting the oscillator or first generator means 1 is split by the power divider means 2 into two signals b and c, wherein the signal b is coupled to the optical emitting means 3, while the signal c acts as the reference signal and is connected directly to the measuring means 7″; in particular, as depicted in FIG. 7, the reference signal e enters the second mixing means 12 together with signal n, namely together with a fraction of the signal a′ coming from the second generator 116 through the second power divider means 15. In the same way, the sensing electrical signal d exiting the optical path 5 comprising the optical generating means or light emitting means 3, the sensing portion 5′ and the optical receiving means and electrical generating means 6, is entered into the first mixing means 9 together with the signal m, namely with a fraction of the signal a′ generated by the second generator means 116.

Considering sinusoidal RF signals, the signals entering the mixer means 9 can be written as
d(t)=D cos(ω₁t+φ)
m(t)=M cos(ω₂t) (11)
where D and M are constants that take into account the attenuations along the respective paths and φ the relative phase shift of the signal d(t) with aspect to the signal m(t). The signal g(t) exiting the first mixer means 9 enters a band-pass filter 17 centered at a frequency f₀. In particular, it is important to note that, in the embodiments described above with reference to previous figures, a low-pass band filter was used, whilst in the present case, a band-pass filter centered at a frequency f₀ is used.

Assuming an ideal behavior of the components, the signal f exiting the band-pass filter 17 may be described by
f(t)=F cos(ω₀t+φ) (12)
that is, a signal having the same phase shift as the sensing signal d but at an angular frequency ω₀, corresponding to the frequency f₀.

The same considerations as stated above also apply to the reference path 4; in fact, in this case, the signals e and n entering the second mixer means 12 can be described by
e(t)=E cos(ω₁t+θ)
n(t)=N cos(ω₂t) (13)

where E and N are constants that take into account the attenuation along the paths and θ the phase shift of the signal e(t) with respect to the signal m(t) or the signal n(t).

Again assuming an ideal behavior, at the output of the band-pass filter 18 centered at the frequency f₀, the signal 1 exiting the band-pass filter 18 may be described by
l(t)=L cos(ω₀t+θ) (14)

That is, a signal having the same phase shift as the reference signal e but at angular frequency ω₀.

It appears clearly from equations 11 and 13 and 12 and 14, respectively, that the signals f and l exiting the first band-pass filter 17 and the second band-pass filter 18, respectively, are sinusoidal signals that maintain the same phase shifts as the sensing signal d and the reference signal e, respectively; however, their frequency is changed from f₁ to f₀. Accordingly, the phase can now be easily measured with good accuracy because the operating frequency is low. Moreover, since the signals f and l are now AC signals, whilst in the previous embodiment the signals exiting the measuring means were DC signals, the signals f and l are no longer sensitive to any offset introduced by the various stages composing the setup. In other words, the embodiment of FIG. 7 overcomes the drawback affecting the embodiment depicted in FIG. 6.

Considering that the phases can also be written in terms of time delays, the phase difference 6 can also be described by

$$δ = ϕ - θ 2 π {f}_{1} Δ {t}_{1} = 2 π {f}_{0} ⇒ Δ {t}_{0} = \frac{{f}_{1}}{{f}_{0}} Δ {t}_{1} \qquad ( 15 )$$

Equation (15) implies that the same phase difference 6 at the frequency f₀ results in a time delay corresponding to f₁/f₀ x the time delay at the frequency f₁. In other words, the same variation in the length of the sensing path 5, in the length of the sensing portion 5′, produces a much stronger effect on the signal f(t) than on the signal d(t). For example, considering standard POF both for the sensing and reference paths 5 and 4, f₁=20 MHz and f₀=1 kHz, a length variation of 1 cm produces a phase difference δ circa 0.36°, corresponding to a time delay of only 50 ps at f₁ but of one microsecond at f₀.

According to the circumstances, the embodiment of FIG. 7 can be modified for the purpose of improving its reliability and/or its sensitivity. For example, a third oscillator, not depicted in FIG. 7, may be introduced, with the third oscillator being locked with the other two generators and working exactly at the frequency f₀. This third generator can be provided to generate a signal for a lock-in filter or other narrow band-filters, also not depicted in FIG. 7, that may be implemented either in hardware form or via software to recover the signals f(t) and l(t) in the case of particularly noisy signals.

The measurement of the phase between signals f(t) and l(t) can be performed in several ways because the involved signals are low frequency signals. For example, this can be done by means of a PC connected to the circuit through a digitizing acquisition board. Then a user-friendly program can also be used to control the whole measurement procedure and compute the displacement. In this case the program should perform the operations described in the following steps.

First, acquiring the signals f(t) and l(t).

Second, optionally, acquiring the reference signal at f₀ from the third generator.

Third, reconstructing ideal noise-free signals from the acquired ones. If the third generator is used this may be done by recovering the signal parameters using a digital lock-in technique (i.e., a sort of synchronous detection) or other narrow-band filtering techniques, otherwise a three-parameter or four-parameter sine-fit may be used.

Fourth, measuring the time delay between the reconstructed noise-free signals and estimating the variation in length of the sensing fiber with respect to a previously stored measure taken at the zero value.

Fifth, repeating the whole procedure hundreds of times and the average value and standard deviation are computed to give the user an estimation of the confidence of the measurement process.

In all the embodiments described above with reference to FIGS. 1 to 7, the sensing portion 5′ of the optical sensing path has been described as that portion of the optical path included between the two locks or fixed means 8. However, it has been revealed to be difficult in all these embodiments to ensure that the rest of the sensing path, that portion of the sensing path outside the two blocks or fixed means 8, is not influenced by a mechanical action or force acting on the transducer. In practice, also the transmission of the optical and/or electrical signal through portions of the sensing path other than the sensing portion 5′ is influenced and/or modified by a mechanical action or force acting on the transducer; in other words, in all the embodiments described above, the entire length of the sensing path may somehow affect the output of the transducer, even if the part outside the sensing portion 5′ is kept loose and within a protective housing.

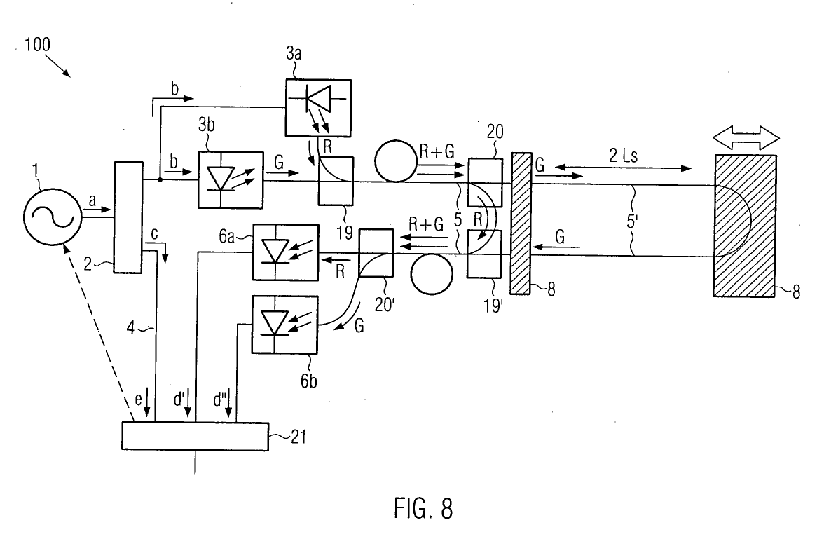

This unwanted effect can be overcome considering a two wavelength scheme as depicted in FIG. 8, where, as usual, like features or component parts already described with reference to previous figures are identified by like reference numerals.

As apparent from FIG. 8, the above mentioned two-wavelength approach has been applied to an embodiment similar to that depicted in FIG. 2; however, it will become apparent to those skilled in the art that the two wavelength approach can be applied to any of the embodiments described above, including the embodiment depicted in FIG. 7.

The most important difference between the embodiment of FIG. 8 and the embodiment of FIG. 2 relates to the fact that in the embodiment of FIG. 8, first and second light or optical emitting means 3a and 3b are used, as well as first and second light or optical receiving means 6a and 6b; moreover, a first and a second wavelength insensitive power splitter or divider 19 and 19′ and first and second wavelength sensitive power splitter or divider 20 and 20′ are used. Furthermore, in the embodiment of FIG. 8, the measuring means 21 are adapted to process the two sensing electrical signals d′ and d″ arising from two optical sensing signals G and R at different wavelengths. In particular, in FIG. 8, these two signals at different wavelengths are identified by G (green) an R (red); however, any other wavelength may be used, according to the circumstances.

In the embodiment of FIG. 8, the signal a generated by the generator means 1 is split by the power splitter or divider means 2 into a sensing signal b and a reference signal c. The reference signal c goes directly to the phase processing unit or measuring means 21 through the reference path 4; in particular, the reference signal c is received by the phase processing unit or measuring means 21 as a reference signal e. The sensing signal b is fed to first and second light or optical emitting means 3a and 3b, respectively, adapted to convert the signal b into a first optical signal at a predefined wavelength, the R signal, and a second sensing optical signal at a second predefined wavelength, the signal G. The red and green optical signals R and G are injected together into the sensing part 5 through a first combiner 19 (i.e. a wavelength insensitive power splitter used as a combiner); then, just before the first lock or fixed means 8, a first wavelength sensitive splitter 20 drops the red signal R that is immediately recombined by another power combiner 19′ with the green signal R that has been going through the sensing portion 5′. Moreover, a further wavelength sensitive splitter 20′ de-multiplexes the two red and green signals R and G and routes them to two optical receiving means 6a and 6b, respectively; the resulting electrical signals d′ and d″ exiting the optical receiving means 6a and 6b enter then the phase processing unit or measuring means 21. By comparing the phase shift variation of the electrical signals d′ and d″ coming form the red and green optical signals R and G, it is, therefore, possible to compensate for the unwanted deformations and measure only the displacement in the sensing region or portion 5′ bounded by the two locks or fixed means 8. In particular, if the variation in the phase shift between, on the one hand, the reference signal e and the first sensing signal d′ and, on the other hand, the variation in the phase shift between the reference signal e and the second sensing signal d″ are measured, an indication can be obtained of the variation in the phase shift δ arising from influences other than the mechanical action or force acting on the sensing portion 5′ so that this mechanical action, displacement, or force may be detected and measured accurately.

Furthermore, it is also possible to recover not only the variation in the length Ls of the sensing portion 5′ but also its absolute value without the necessity of a prior calibration; in particular, this is possible by combining the two wavelength technique with a frequency variable generator or a two frequency generator in order to make measurements both at a frequency low enough not to have ambiguities in the fiber length and a frequency high enough to obtain the desired resolution. A variation of the scheme shown in FIG. 8 where only single receiving means are necessary can also be implemented. In this case the two R and G signals exiting from the combiner 19′ are routed directly to the receiving means 6a. Then the separation between the two wavelengths can be done by time switching on and off alternatively at an appropriate rate with the two sources 3a and 3b. In this way it is possible to have an output signal d′ that alternatively represent the reading associated with the R and with G signals so that the compensation for the unwanted deformations or the measure of the absolute distance can be completed using the same previously described procedure.

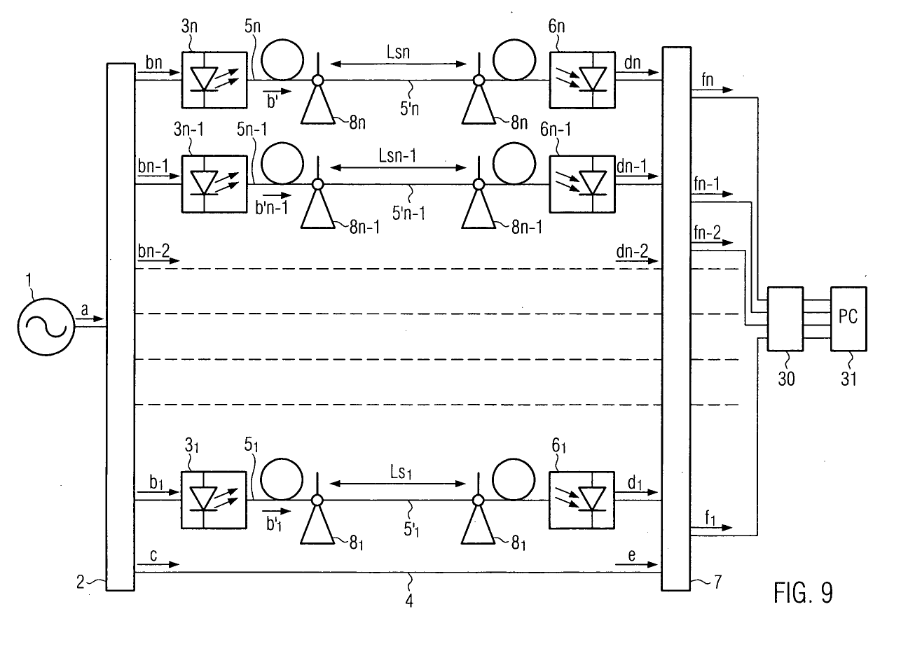

All the embodiments described above with reference to FIGS. 1 to 8 allows the detection and/or measurement of mechanical actions, forces, or displacements acting on the transducer; accordingly, if a plurality of transducers is provided, a measuring device can be obtained allowing to detect a plurality of mechanical actions, forces, displacements, stresses or the like simultaneously. An example of such a measuring device will be described in the following with reference to FIG. 9, wherein, again, like features and/or component parts already described with reference to previous figures are identified by like reference numerals.

In the embodiment of FIG. 9, a plurality of optical sensing paths as described above with reference to FIG. 1 is used; however, it will be appreciated by those skilled in the art that the solution depicted in FIG. 9 may be realized also by implementing one of the optical paths described above with reference to any of the FIGS. 2 to 8.

As apparent from FIG. 9, the electrical signals generated by the generator means 1 are split by the power divider means 2 into a plurality of electrical signals b₁-bₙ and into a unique reference signal c. The reference signal c enters the reference path 4 at the end of which the reference signal c is collected by the measuring means 7 as a reference electrical signal e. The sensing electrical signals b₁ to bₙ are converted by the optical emitting means 3₁ to 3ₙ into a corresponding plurality of sensing optical signals b′₁ to b′ₙ which, in turn, enters a plurality of sensing portions 5′₁, to 5′ₙ. Once having gone through the sensing portions 5′₁ to 5′ₙ, and after having been eventually modified by mechanical actions or forces acting on the sensing portions, the optical signals b′₁ to b′ₙ are converted into corresponding electrical sensing signals d₁ to dₙ by a corresponding plurality of optical receiving means 6₁ to 6ₙ. The sensing signals d₁ to dₙ and the reference signal e are collected by the measuring means 7, for instance comprising a plurality of mixers and low-pass filters as depicted in FIG. 3, so that a plurality of output signals f₁ to fₙ are emitted. The signals are, therefore, collected by an acquisition board 30 and sent to a computing unit 31 such as, for instance, a personal computer.

The measuring device depicted in FIG. 9 has been revealed to be particularly advantageous when used for the detection of mechanical actions or forces acting on different regions of, for instance, a building or the like. In fact, with the measuring device of FIG. 9, each of the sensing paths 5₁ to 5ₙ can be provided so as to correspond to each critical region to be detected, thus allowing the detection and measuring of the mechanical actions or forces acting on a plurality of separated regions.

Summarizing, it arises from the above disclosure that the optical transducers and the measuring devices according to the present invention overcome or at least minimize the drawbacks affecting the prior transducers known in the art; in particular, the optical transducers and the measuring devices according to the present invention allow the reliably detection of mechanical actions or forces such as, for instance, tensile forces and/or compressive forces, as well as stresses, displacements, shocks or the like. Moreover, the optical transducers and the measuring devices according to the present invention allow detection of both mechanical actions, stresses, displacements or the like acting on or arising in a single region and multiple mechanical actions, forces stresses, displacements or the like, acting on or arising in corresponding multiple regions.

The optical transducers and the measuring devices according to the present invention can be applied to the inspection of damage to structures, and especially to composite structures. They can be applied, for example, to the checking of constructive work and to the measurement of strains. The checking of damage to and/or displacements in structures can be done by inserting one or more of the optical transducers according to the present invention into the structure to be checked, for instance by fixing the sensing optical paths to the regions to be inspected while leaving the reference path unexposed to any mechanical actions or forces. In particular, the optical transducers according to the present invention have been revealed to be useful for the measurement of movement or forces on iron beams used to improve the structural stability of walls, especially in ancient buildings or after earthquakes. Measurement of the formation of landslides is also possible, for instance by fixing the transducer between poles in the ground. Furthermore, the optical transducers according to the present invention allow the measurement of deformation in composite materials by incorporating the sensing optical path into the structure. In the same way, measurement of distances and displacements in hostile environments, such as highly flammable, explosive or electro-magnetically noisy environments, are also possible, as well as measurement of forces in bioengineering.

Useful implementations of the optical transducers according to the present invention can be obtained by connecting the transducers to a PC or computer equipped with a digitizing card (DAQ) through a low noise multiple channel amplifier; of course, the PC or computer can control several transducers simultaneously, so that it is possible to devise complex yet quite inexpensive network of sensors. Moreover, using suitable software, it is also possible to control the sensors via a remote network such as the internet or web using standard protocols such as TCP/IP.

The optical transducers according to the present invention are characterized by quite extended operation range, from 10 μm up to several centimeters, while keeping a good resolution. Moreover, no interruption of the optical path, of the optical fiber, is necessary, thus resulting in better isolation from dust, rain or the like, making these transducers particularly suitable for outdoor applications.

The transducers according to the present invention have been tested using standard commercial POF having the objective to keep the costs as low as possible. Then, considering the modulation bandwidth of the typically available light emitting diodes or LEDs, a frequency f₁ was used, corresponding to 20 MHz, with f₂=f₁+1 kHz, as well as commercial signal generators. However, other solutions based on DDS chips and microcontrollers may also be implemented.

It has finally to be noted that, in the optical transducers according to the present invention, both glass or polymer optical fibers may be implemented or used, depending on the circumstances. In particular, if the resolution requirements are in the order of millimeters and the operation temperature allows it, polymer optical fibers can be used for the sensing path. This implies very low costs in terms of sources, detectors and connectors, besides the advantages common to all the types of optical fiber sensors such as light weight, minimal invasiveness, immunity to electromagnetic interferences and impossibility to start a fire or an explosion. The latter two properties are particularly interesting because they allow the transducers to be used in critical environments such as in electromagnetically noisy industrial premises, in storage areas of high flammable materials, in structures exposed to electrostatic discharges during thunderstorms and in the monitoring of monuments or art pieces in general. The absence of electrical currents flowing through the transducer makes this transducer also ideal for biomedical applications so as to avoid a risk of electrocution. Moreover, thanks to their higher deformability, polymer optical fibers allow longer displacements to be measured with respect to commercial silicate fibers.

It has also to be noted that the principle of working of the optical transducer according to the present invention is based on the relative phase shift of electrical signals and not on the interference of optical signals.

While the present invention has been described with reference to particular embodiments, it has to be understood that the present invention is not limited to the particular embodiment described but rather that various modifications may be introduced into the embodiments described without departing from the scope of the present invention, which is defined by the appended claims.

What is claimed is:

1. An optical transducer adapted to detect external mechanical actions acting on the optical transducer comprising:
at least one sensing optical path (5) adapted to transmit at least one sensing optical signal (b′) and to emit at least one sensing output electrical signal (d);
at least one reference path (4) adapted to emit at least one output reference electrical signal (e);
at least one sensing portion (5′) of said at least one optical path (5) being adapted to be exposed to external mechanical actions, so that the transmission of said sensing optical signal (b′) through said sensing optical path can be modified, resulting in a phase shift between said sensing electrical signal (d) and said reference electrical signal (e) being generated; and
phase shifting means (11) adapted to maintain the phase shift between said at least one output sensing electrical signal (d) and said at least one output reference electrical signal (e) at a constant value in absence of any mechanical action exerted on said at least one sensing optical path (5).

2. An optical transducer as claimed in claim 1, further comprising:
means (14) adapted to collect said at least one electrical reference signal (e) and to emit a further electrical reference signal (h), with said signal (h) being shifted in a phase with respect to said signal (e) of approximately 90°.

3. An optical transducer as claimed in claim 1 further comprising:
generator means (116) for generating at least one additional electrical signal (a′) at a frequency f₂ slightly differing from a frequency f₁ of said at least one reference output electrical signal (e).

4. An optical transducer as claimed in claim 3, further comprising:
divider means (15), adapted to receive said at least one additional electrical signal (a′), for dividing said at least one additional electrical signal (a′) into two electrical signals (m) and (n).

5. An optical transducer as claimed in claim 1, wherein:
said optical path is adapted to transmit at least two optical sensing signals (G) and (R) with corresponding different wavelengths, with only one signal (G) of said at least two optical sensing signals (G) and (R) entering said at least one sensing portion (5′), said optical path further comprising means for receiving said at least two sensing optical signals (G) and (R) and to convert said at least two sensing optical signals (G) and (R) into two corresponding output sensing electrical signals (d″) and (d′).

6. An optical transducer as claimed in claim 1, wherein:
said at least one sensing portion (5′) of said at least one sensing optical path (5) has a predefined length (Ls) adapted to be modified as a result of mechanical actions acting on said at least one sensing portion (5′).

7. An optical transducer as claimed in claim 1, wherein:
said at least one sensing optical path (5) comprises optical receiving means (6) for receiving said at least one sensing optical signal (b′) and converting said at least one optical signal (b′) into said at least one sensing electrical signal (d).

8. An optical transducer as claimed in claim 7, wherein:
said optical receiving means (6) comprises a photo diode.

9. An optical transducer as claimed in claim 7, wherein:
said optical receiving means (6) comprise a photo transistor.

10. An optical transducer as claimed in claim 1, wherein:
said at least one sensing optical path (5) comprises optical emitting means (3) for receiving at least one input sensing electrical signal (b) and converting said at least one input sensing electrical signal (b) into said at least one sensing optical signal (b′).

11. An optical transducer as claimed in claim 10, wherein:
said optical emitting means (3) comprises a light emitting diode.

12. An optical transducer as claimed in claim 10, wherein:
said optical emitting means comprises a laser diode.

13. An optical transducer as claimed in claim 1, wherein:
at least said one sensing portion (5′) of said at least one sensing optical path (5) comprises an optical fiber.

14. An optical transducer as claimed in claim 13, wherein:
the optical fiber is a polymer optical fiber.

15. An optical transducer as claimed in claim 1, wherein:
said at least one reference path (4) comprises a copper wire.

16. An optical transducer as claimed in claim 1, wherein:
said at least one reference path (4) comprises a coaxial cable.

17. An optical transducer as claimed in claims 1, wherein:
said at least one reference path (4) comprises a reference optical path adapted to transmit at least one reference optical signal and optical receiving means for receiving said at least one reference optical signal and converting said at least one reference optical signal into said at least one reference electrical signal (e).

18. An optical transducer as claimed in claim 17, wherein:
said at least one reference path comprises optical emitting means for receiving at least one reference electrical signal (c) and to convert said at least one reference electrical signal (c) into said at least one reference optical signal.

19. An optical transducer as claimed in claim 17, wherein:
said reference optical path comprises an optical fiber.

20. An optical transducer as claimed in claim 1, wherein:
said at least one sensing portion (5′) of said at least one sensing optical path (5) comprises at least two rectilinear portions disposed parallel one to each other and joined by a curved portion.

21. An optical transducer as claimed in claim 1, further comprising:
a plurality of sensing optical paths (5₁-5ₙ) each adapted to transmit at least one corresponding sensing optical signal (b′₁-b′ₙ) and to emit at least one corresponding sensing output electrical signal (d₁-dₙ) and each comprising at least one portion (5′₁-5′ₙ) adapted to be exposed to external mechanical actions.

22. A measuring device for measuring or detecting mechanical actions comprising:
at least one sensing optical path (5) adapted to transmit at least one sensing optical signal (b′) and to emit at least one sensing output electrical signal (d);
at least one reference path (4) adapted to emit at least one output reference electrical signal (e);
at least one sensing portion (5′) of said at least one optical path (5) being adapted to be exposed to external mechanical actions, so that the transmission of said sensing optical signal (b′) through said sensing optical path can be modified, resulting in a phase shift between said sensing electrical signal (d) and said reference electrical signal (e) being generated;
phase shifting means (11) adapted to maintain the phase shift between said at least one output sensing electrical signal (d) and said at least one output reference electrical signal (e) at a constant value in absence of any mechanical action exerted on said at least one sensing optical path (5); and
measuring means (7) for measuring the phase shift between said at least one sensing electrical signal (d) and said at least one reference electrical signal (e).

23. A measuring device as claimed in claim 22, wherein:
said measuring means (7) are adapted to collect said at least one output reference electrical signal (e) and said at least one output sensing electrical signal (d) and to emit an output electrical signal (f) so that the phase shift between said at least one output reference electrical signal (e) and said at least one output sensing electrical signal (d) can be measured as a function of the amplitude of said output electrical signal (f).

24. A measuring device as claimed in claim 22, wherein:
said measuring means comprises first measuring means (7′) and second measuring means (7″), said first measuring means for collecting collect said at least one sensing electrical signal (d) and said at least one reference electrical signal (e) and emitting a first output electrical signal (f), said second measuring means (7″) for collecting said at least one output sensing electrical signal (d) and a reference electrical signal (h) shifted in phase by 90° with respect to said reference electrical signal (e) and emitting a second output electrical signal (l) so that the phase shift between said at least one reference electrical signal (e) and said at least one sensing electrical signal (d) can be measured as a function of the amplitude of one or both of said output electrical signals (f) and (l).

25. A measuring device as claimed in claims 24 further comprising:
generator means (116) for generating at least one additional electrical signal (a′) at a frequency f₂ slightly differing from a frequency f₁ of said at least one reference output electrical signal (e).
divider means (15), adapted to receive said at least one additional electrical signal (a′), for dividing said at least one additional electrical signal (a′) into two electrical signals (m) and (n);
wherein the phase shift between said at least one reference electrical signal (e) and said at least one sensing electrical signal (d) can be measured as a function of the time delay of one or both of said electrical signals (f) and (l).

26. A measuring device as claimed in claim 22 wherein:
said measuring means (7) comprises mixing means (9) for mixing said sensing output electrical signal (d) and said output reference electrical signal (e) and emitting electrical signal (g), and in that said measuring means (7) comprises a low-pass filter (10), adapted to receive said electrical signal (g), and to emit electrical signal (f).

27. A measuring device as claimed in claim 25, wherein:
said first and second measuring means (7′) and (7″) comprise mixing means (9) and (12), respectively, adapted to mix the electrical signals (d) and (m) and (n) and (e), respectively, and emitting electrical signals (g) and (i), respectively, and in that said first and second measuring means (7′) and (7″) comprise and a low-pass filter (10) and (13), respectively, centered at a predefined frequency and adapted to receive said output electrical signals (g) and (i), respectively, and to emit electrical signals (f) and (l), respectively.

28. A measuring device as claimed in claim 22 wherein:
said sensing optical path is adapted to transmit at least two optical sensing signals (G) and (R) with corresponding different wavelengths, with only one signal (G) of said at least two optical sensing signals (G) and (R) entering said at least one sensing portion (5′), said sensing optical path further comprising means for receiving said at least two sensing optical signals (G) and (R) and to convert said at least two sensing optical signals (G) and (R) into two corresponding output sensing electrical signals (d″) and (d′); and
wherein said measuring means comprises additional measuring means (21) for measuring the phase difference between said at least one reference electrical signal (e) and the two corresponding output sensing electrical signals (d″) and (d′).

29. A measuring device as claimed in one of claims 22 further comprising:
computing means, coupled to said measuring means, for receiving emitted signals (f, l) exiting said measuring means (7).

30. A measuring device as claimed in claim 29, wherein:
said computing means comprises means (30) for converting analog signals into digital signals.

31. A measuring device as claimed in claim 30, wherein:
said computing means further comprises a personal computer (31) connected to said means (30) for converging analog signals into digital signals.

32. A measuring method for measuring mechanical actions, comprising the steps of:
providing an optical transducer having at least one sensing portion (5′) of at least one optical path (5) exposed to the mechanical actions, and at least one reference path (4);
entering at least one sensing optical signal (b′) into the at least one portion (5′) of the at least one sensing optical path (5) and converting the optical signal (b′) into an output sensing electrical signal (d);
inducing the at least one reference path (4) to emit at least one output reference electrical signal (e);
shifting the phase of the at least one output electrical signal (e) so as to maintain a phase shift between the at least one output reference electrical signal (e) at a constant value in the absence of any action exerted on the at least one sensing optical path (5);
measuring the phase shift between the at least one output sensing electrical signal (d) and said at least one output electrical reference signal (e).

33. A measuring method as claimed in claim 32, further comprising the step of:
fixing the opposed ends of the at least one sensing portion (5′) of the at least one optical path (5) to so that the mechanical actions acting on said sensing portion (5′) results in the length Ls of said sensing portion being modified, thus generating a phase shift between the at least one output sensing electrical signal (d) and the at least one output reference electrical signal (e).

34. A measuring method as claimed in claims 32, wherein:
said step of inducing the inducing said at least one reference path (4) to emit the at least one output electrical reference signal (e) comprises entering into the at least one reference path (4) at least one electrical signal (c).

35. A measuring method as claimed in claim 32, wherein:
said step of inducing the at least one reference path (4) to emit the at least one output reference electrical signal (e) comprises entering into said at least one reference path (4) at least one reference optical signal and converting the at least one reference optical signal into the at least one output electrical reference signal (e).

36. A measuring method as claimed in claim 32, further comprising the steps of:
collecting the two signals (d) and (e), mixing the two signals (d) and (e) so as to obtain a signal (g), filtering the signal (g) obtaining a signal (f) and collecting the signal (f).

37. A measuring method as claimed in claim 32 further comprising the steps of:
collecting the two signals (d) and (e), mixing the two signals (d) and (e) so as to obtain a signal (g), filtering the signal (g) obtaining a signal (f), shifting the phase of said output reference electrical signal (e) by a constant value so as to obtain a second output electrical reference signal (h), collecting the two signals (d) and (h), mixing the two signals (d) and (h) so as to obtain a signal (i), filtering the signal (i) obtaining a signal (l) and collecting one or both of the signals (f) and (l).

38. A measuring method as claimed in claim 32, further comprising the steps of:
generating at least one additional electrical signal (a′) at a frequency f₂ slightly differing from a frequency f₁ of the at least one reference output electrical signal (e), dividing the at least one additional signal (a′) in to two electrical signals (m) and (n), collecting the two signals (d) and (m), mixing the two signals (d) and (m) so as to obtain a signal (g), filtering the signal (g) centered at a predefined frequency obtaining a signal (f), collecting the two signals (n) and (e), mixing the two signals (n) and (e) so as to obtain a signal (i), filtering the signal (i) centered at a predefined frequency obtaining a signal (l) and collecting one or both of the signals (f) and (l).

39. A method as claimed in claim 37, further comprising:
processing or computing one or both of the two signal (f) and (l).

40. A method as claimed in claim 39, wherein:
said step of processing or computing comprises converting one or both of the signals (f) and (l) into digital signals.

41. A method as claimed in claim 32 further comprising the step of:
measuring the phase shift between the output sensing electrical signal (d) and the at least one output reference electrical signal (e) in absence of any mechanical action acting on the at least one portion (5′) of the at least one optical sensing path (5).

42. An optical transducer for detecting a mechanical action comprising:
an optical fiber having an optical sensing path and a sensing portion adapted to carry a sensing signal, whereby a sensing output signal is formed;
a reference conductor adapted to carry a reference signal, whereby a reference output signal is formed; and
a phase measurer coupled to an output of the sensing portion of said optical fiber and an output of said reference conductor adapted to measure a phase difference between the sensing output signal and the reference output signal,
whereby when the sensing portion is placed adjacent the mechanical action, the mechanical action is detected due to the phase difference.

43. An optical transducer as in claim 42 further comprising:
a phase shifter, said phase shifter maintaining a predestined phase shift between the sensing output signal and the reference output signal,
whereby a maximum signal sensitivity range is obtained.

44. A method for detecting mechanical actions comprising the steps of:
transmitting an optical signal through a sensing optical path having a sensing optical path portion adjacent a mechanical action to be detected resulting in a sensing output signal having a sensing phase;
transmitting a reference signal having a reference phase through a reference path;
detecting the sensing phase of the sensing output signal and the reference phase of the reference signal;
calculating the mechanical action based upon a difference in the sensing phase of the sensing output signal and the reference phase of the reference signal,
whereby the mechanical action is detected.

45. A method for detecting mechanical actions as in claim 44 further comprising:
maintaining a predestined phase shift between the sensing output signal and the reference output signal,
whereby a maximum signal sensitivity range is obtained.
